(19) United States
(12) Patent Application Publication
(10) Pub. No.: US 2015/0003888 A1
(43) Pub. Date: Jan. 1, 2015

(54) COUPLER SLEEVE FOR PEN AND PEN USING THE SAME

(71) Applicant: DAYACOM INDUSTRIAL CO., LTD, Taipei City (TW)

(72) Inventor: Angus LEE, Taipei City (TW)

(21) Appl. No.: 13/927,925

(22) Filed: Jun. 26, 2013

(51) Int. Cl. B43K 24/06

(52) U.S. Cl. CPC B43K 24/06
USPC 401/116

(57) ABSTRACT

A coupler sleeve for a pen and the pen using the coupler sleeve are provided, wherein the sleeve portion at the lower end of the main body is used for inserting into the upper opening of the lower pen tube to engage the outer protruded ring on the upper opening of the lower pen tube. Thereby, when a refill sleeve column for Cross-type refills is inserted inside the main body, a rotating portion of the refill sleeve column can be tightly sleeved in a fastening section of the sleeve portion, and the lower pen tube and the fastening section of the sleeve portion are pressed by the rotating portion in order to be fixed tightly and relatively at positions, so that the refill can be turned outside or inside of the lower pen tube by turning the upper pen tube and the lower pen tube relatively.

### BACKGROUND OF THE INVENTION

1. Field of Invention

The present invention relates to a coupler sleeve for a pen and the pen using the coupler sleeve and more particularly to a pen with an 8.5 mm outer diameter being installed with a refill sleeve column for Cross-type refills by using the coupler sleeve.

2. Related Art

Besides the usages of writing for studying and working, pens with pen shafts delicately made have become precious collections for enthusiasts. For rotation mechanical pens with an 8.5 mm outer diameter, a refill can be extended outside of or retracted inside a lower pen tube by turning an upper pen tube and the lower pen tube relatively. A length of the mechanical pen can be maintained the same when the refill is extended or retracted. Therefore, rotation mechanical pens do not have the problem of the upper pen tube falling off happened in traditional pens, and have the advantages of convenient to use and carry around.

However, because refills cannot be fixed properly inside the lower pen tube in rotation mechanical pens, the refills may easily sway during writing, which makes rotation mechanical pens inconvenient to use. Furthermore, usually a protruded length of the refill cannot be maintained the same after the rotation mechanical pen has been used for a long time. Additionally, an inner diameter of the lower pen tube of rotation mechanical pens with an 8.5 mm outer diameter is 8 mm, while an outer diameter of a refill sleeve column for using with Cross-type refills is 6.3 mm, which causes Cross-type refills unable to be directly used in rotation mechanical pens with an 8.5 mm outer diameter.

### SUMMARY OF THE INVENTION

In view of the above drawbacks, a coupler sleeve for a pen is provided by the present invention for holding and supporting a refill sleeve column in order to fix a refill inside the pen.

A primary objective of the present invention is to provide a coupler sleeve for a pen. A sleeve portion is used for inserting into an upper opening of a lower pen tube of the pen. Thereby, when a refill sleeve column is inserted into a main body, a rotating portion of the refill sleeve column can be tightly sleeved in a fastening section of the sleeve portion, and the lower pen tube and the fastening section of the sleeve portion are pressed by the rotating portion in order to be fixed tightly correspondingly at positions, so that an upper pen tube and the lower pen tube of the pen can be coupled together.

A secondary objective of the present invention is to provide a pen. An outer diameter of both the upper pen tube and the lower pen tube of the pen is 8.5 mm, and an inner diameter of the lower pen tube is 8 mm. A cross-type refill is inserted into a refill sleeve column with a 6.3 mm outer diameter. Thereby, when the refill sleeve column is inserted into the coupler sleeve disposed at the upper opening of the lower pen tube, the cross-type refill can be fixed inside the pen with the 8.5 mm outer diameter.

In order to achieve the above-mentioned objectives, the coupler sleeve for the pen of the present invention comprises the main body, an outer protruded ring and the sleeve portion. Through holes penetrated with each other are disposed at two ends of the main body. The through hole at an upper end of the main body is used for inserting the refill sleeve column. The outer protruded ring is protrudingly disposed at the upper end of the main body. An outer diameter of the outer protruded ring is larger than the inner diameter of the lower pen tube. The sleeve portion is disposed at a lower end of the main body. An outer diameter of the sleeve portion is smaller than the inner diameter of the lower pen tube. A fastening section with an outer diameter slightly smaller than the inner diameter of the lower pen tube is formed on the sleeve portion. The sleeve portion is used for inserting into the upper opening of the lower pen tube in order to engage the outer protruded ring on the upper opening of the lower pen tube. Thereby, when the refill sleeve column is inserted inside the main body, the rotating portion of the refill sleeve column can be tightly sleeved in the fastening section of the sleeve portion, and the lower pen tube and the fastening section of the sleeve portion are pressed by the rotating portion in order to be fixed tightly correspondingly at positions, so that when a lower opening of the upper pen tube is sleeved around a fixing portion of the refill sleeve column, the refill can be turned outside or inside of the lower pen tube by turning the upper pen tube and the lower pen tube relatively.

When the coupler sleeve for the pen and the pen using the coupler sleeve are embodied, a decoration layer made of wood or acryl is disposed on an outer surface of the upper pen tube.

When the coupler sleeve for the pen and the pen using the coupler sleeve are embodied, the outer diameters of the outer protruded ring, the upper pen tube and the lower pen tube are 8.5 mm.

When the coupler sleeve for the pen and the pen using the coupler sleeve are embodied, a step portion is formed on an inner wall of the main body at a lower edge of the fastening section.

The present invention will become more fully understood by reference to the following detailed description thereof when read in conjunction with the attached drawings.

### BRIEF DESCRIPTION OF THE DRAWINGS

FIG. 1 is a schematic view of a coupler sleeve for a pen according to a first embodiment of the disclosure;

FIG. 2 is a schematic combinational view of the pen using the coupler sleeve in FIG. 1;

FIG. 3 is a perspective view of the pen in FIG. 2 after combination;

FIG. 4 is a sectional view of the pen in FIG. 3;

FIG. 5 is a sectional view of an a portion of the pen in FIG. 4;

FIG. 6 is a schematic view of the coupler sleeve for the pen according to a second embodiment of the disclosure;

FIG. 7 is a schematic view of the coupler sleeve for the pen according to a third embodiment of the disclosure; and

FIG. 8 is a schematic view of the coupler sleeve for the pen according to a fourth embodiment of the disclosure.

### DETAILED DESCRIPTION OF THE INVENTION

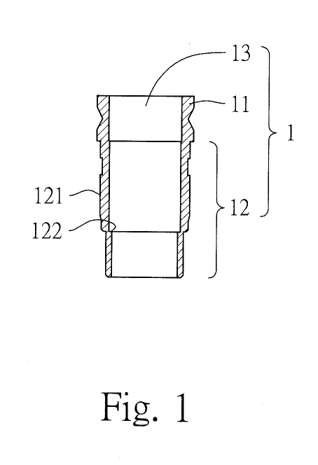

Please refer to FIG. 1. FIG. 1 is a schematic view of a coupler sleeve for a pen according to a first embodiment of the disclosure. The coupler sleeve comprises a main body 1, an outer protruded ring 11 and a sleeve portion 12. Through holes 13 penetrated with each other are disposed at two ends of the main body 1. The outer protruded ring 11 is protrudingly disposed at an upper end of the main body 1. A maximum outer diameter of the outer protruded ring 11 is 8.5 mm.

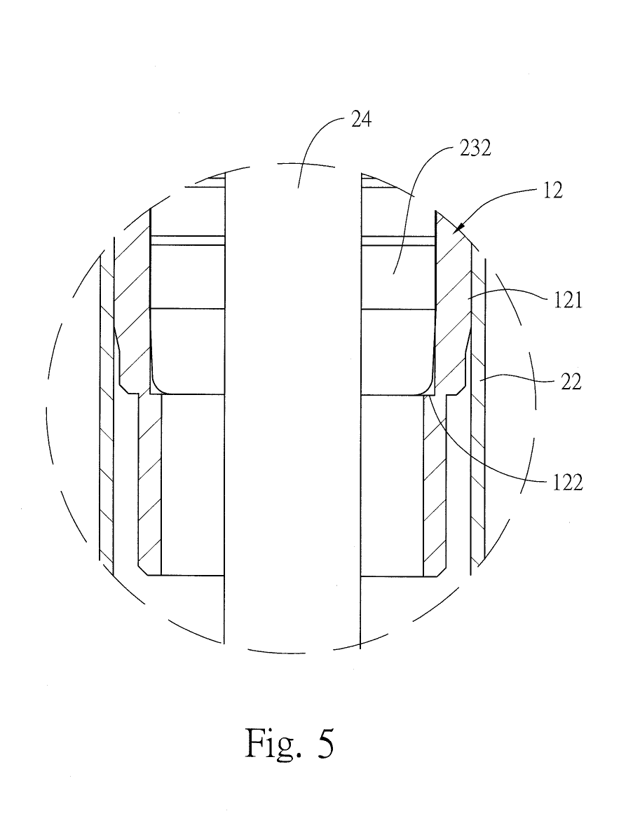

The sleeve portion 12 is disposed at a lower end of the main body 1. A maximum outer diameter of the sleeve portion 12 is smaller than the maximum outer diameter of the outer protruded ring 11. Furthermore, a fastening section 121 with an expanded outer diameter is formed on a middle section of the sleeve portion 12, and an inner diameter of the fastening section 121 is larger than an inner diameter of other part of the sleeve portion 12. Thereby, a step portion 122 is formed on an inner wall of the main body 1 at a lower edge of the fastening section 121 as shown in FIG. 5.

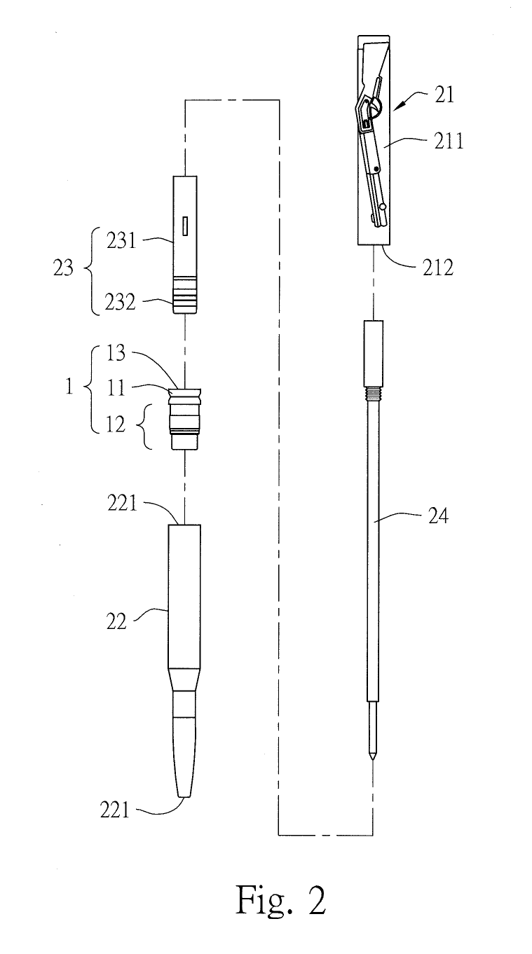

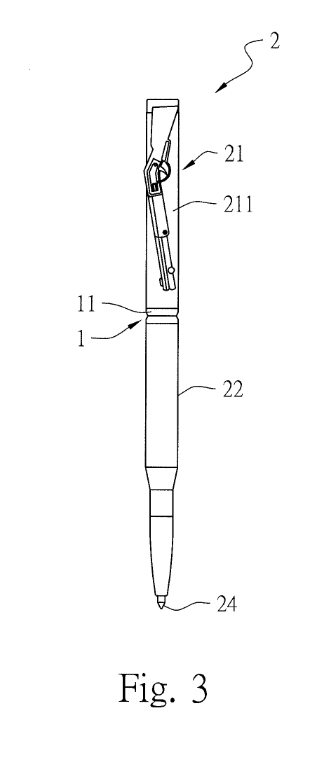

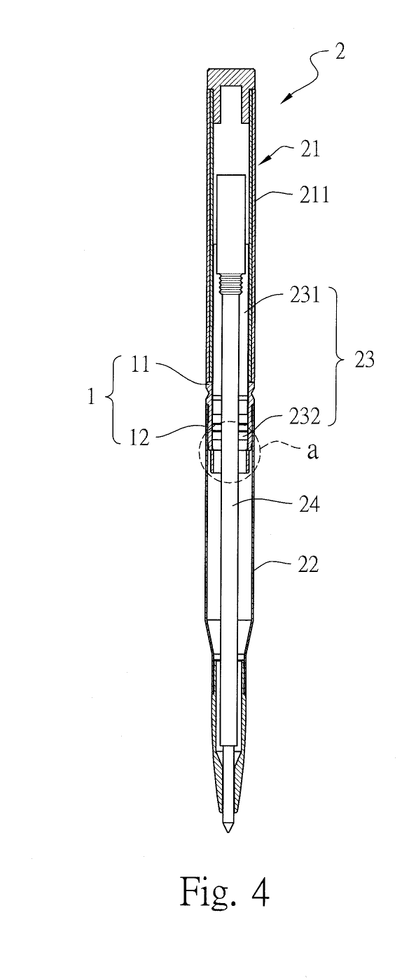

When the coupler sleeve for the pen and the pen using the coupler sleeve are embodied as shown in FIGS. 2 to 4, the outer diameter of the sleeve portion 12 of the main body 1 is smaller than an inner diameter of a bullet-shaped lower pen tube 22 of a pen 2, and the outer diameter of the fastening section 121 is slightly smaller than the inner diameter of the bullet-shaped lower pen tube 22. Thereby, the main body 1 can be coupled with the bullet-shaped lower pen tube 22 by inserting the sleeve portion 12 into an upper opening 221 of the bullet-shaped lower pen tube 22. The pen 2 is further disposed with an upper pen tube 21 and a refill sleeve column 23. A maximum outer diameter of the refill sleeve column 23 is 6.3 mm. The refill sleeve column 23 is disposed with a fixing portion 231 and a rotating portion 232 which can be turned and screwed together relatively to each other. A Cross-type refill 24 can be inserted into the fixing portion 231 and the rotating portion 232, and screwed and fixed on the fixing portion 231. A decoration layer 211 made of wood or acryl is disposed on an outer surface of the upper pen tube 21. Outer diameters of the upper pen tube 21 and the bullet-shaped lower pen tube 22 are 8.5 mm. An inner diameter of the bullet-shaped lower pen tube 22 is 8 mm.

Furthermore, the outer diameter of the outer protruded ring 11 is 8.5 mm, which is larger than the inner diameter of the bullet-shaped lower pen tube 22. Thereby, after the sleeve portion 12 is inserted into the bullet-shaped lower pen tube 22, the outer protruded ring 11 is engaged and fastened on the upper opening 221 of the bullet-shaped lower pen tube 22. Then, when the refill sleeve column 23 is inserted into the main body 1 through the through hole 13 at the upper end of the main body 1 in order to sleeve the rotating portion 232 of the refill sleeve column 23 tightly in the fastening section 121 of the sleeve portion 12; a lower edge of the rotating portion 232 of the refill sleeve column 23 can be pressed against the step portion 122 on the inner wall of the main body 1; and the bullet-shaped lower pen tube 22 and the fastening section 121 of the sleeve portion 12 can be tightly pressed together by the rotating portion 232. Thereby, when a lower opening 212 of the upper pen tube 21 is sleeved and fastened around the fixing portion 231 of the refill sleeve column 23, the refill can be turned outside or inside of the lower opening 221 of bullet-shaped lower pen tube 22 by turning the upper pen tube 21 and the bullet-shaped lower pen tube 22 relatively.

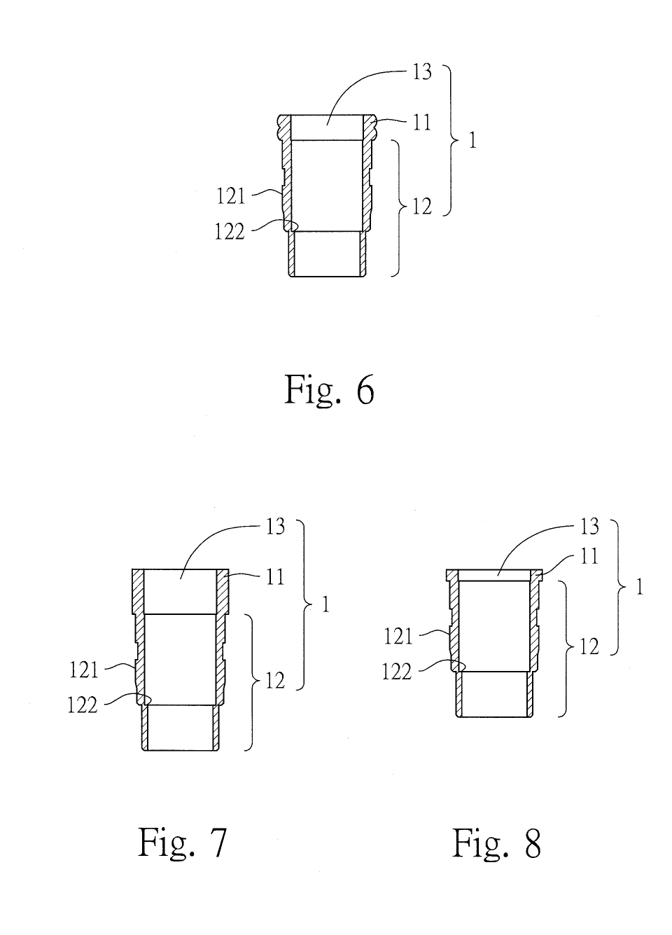

Please refer to FIGS. 6 to 8. FIGS. 6 to 8 are schematic views of the coupler sleeve for the pen according to second, third and fourth embodiments of the present invention. The structures of the coupler sleeve for the pen in the first embodiment are used as the basis for changing the outer protruded ring 11 into different shapes. However, the maximum outer diameters of the outer protruded ring 11 in the second, third and fourth embodiments are still 8.5 mm.

Therefore, the present invention has the following advantages:

1. By using the present invention, the refill sleeve column with the 6.3 mm outer diameter used with Cross-type refills can be fixed inside the bullet-shaped lower pen tube with the 8 mm inner diameter in order that Cross-type refills can be applied inside the pen with the 8.5 mm outer diameter.

2. By using the present invention, the refill sleeve column can be firmly disposed inside the bullet-shaped lower pen tube with the 8.5 mm outer diameter in order to prevent the refill from swaying during writing or the condition of different protruded lengths of the refill from occurring.

As a conclusion from the above mentioned descriptions, the expected objectives can be achieved by the simple structured coupler sleeve for the pen provided by the present invention. By using the coupler sleeve for the pen, the refill sleeve column for Cross-type refills can be firmly installed inside the pen with the 8.5 mm outer diameter.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A coupler sleeve for a pen, wherein the pen is disposed with an upper pen tube, a lower pen tube and a refill sleeve column, and the refill sleeve column is disposed with a fixing portion and a rotating portion which can be screwed together relatively to each other for inserting a refill inside, the coupler sleeve comprises:
a main body, provided with through holes connected to each other at two ends thereof, wherein the through hole at an upper end of the main body is used for inserting the refill sleeve column;
an outer protruded ring protrudingly disposed at the upper end of the main body, wherein an outer diameter of the outer protruded ring is larger than an inner diameter of the lower pen tube; and
a sleeve portion disposed at a lower end of the main body, wherein an outer diameter of the sleeve portion is smaller than the inner diameter of the lower pen tube, and a fastening section with an outer diameter slightly smaller than the inner diameter of the lower pen tube is formed on the sleeve portion, wherein the sleeve portion is used for inserting into an upper opening of the lower pen tube in order to engage the outer protruded ring on the upper opening of the lower pen tube, thereby, when the refill sleeve column is inserted inside the main body, the rotating portion of the refill sleeve column can be tightly sleeved in the fastening section of the sleeve portion, and the lower pen tube and the fastening section of the sleeve portion are tightly pressed and fixed by the rotating portion, so that when the upper pen tube is sleeved around the fixing portion of the refill sleeve column, the refill can be turned outside or inside of the lower pen tube by turning the upper pen tube and the lower pen tube relatively.

2. The coupler sleeve for the pen as claimed in claim 1, wherein a decoration layer is disposed on an outer surface of the upper pen tube.

3. The coupler sleeve for the pen as claimed in claim 1, wherein the outer diameter of the outer protruded ring or an outer diameter of the upper pen tube and the lower pen tube is 8.5 mm.

4. The coupler sleeve for the pen as claimed in claim 1, wherein a step portion is disposed on an inner wall of the sleeve portion at a lower edge of the fastening section.

5. A pen using the coupler sleeve as claimed in claim 1.
